(19) United States
(12) Patent Application Publication
(10) Pub. No.: US 2022/0143735 A1
(43) Pub. Date: May 12, 2022

(54) WELDING TORCH

(71) Applicant: TRAFIMET GROUP S.P.A., Castegnero (VI) (IT)

(72) Inventor: Attilio IMI, Pagnacco (UD) (IT)

(73) Assignee: TRAFIMET GROUP S.P.A., Castegnero (VI) (IT)

(21) Appl. No.: 17/428,066

(22) PCT Filed: Feb. 6, 2020
(86) PCT No.: PCT/IB2020/050951

§ 371 Date: Aug. 3, 2021

(30) Foreign Application Priority Data
Feb. 13, 2019 (IT) 102019000002113

(51) Int. Cl. B23K 9/28; B23K 9/32

(52) U.S. Cl. CPC B23K 9/285; B23K 9/323

(57) ABSTRACT

A welding torch includes a first terminal zone provided with a welding electrode and a conveyor element associated with the electrode. The torch includes a first body connected to the electrode through a first conductor element and a second body connected to the conveyor element through a second conductor element. The torch includes a delivery way suited to convey a cooling fluid towards the first terminal zone and a return way for the cooling fluid coming from the terminal zone. One of the delivery way and the return way passes through the first body and the second body. It includes a tubular element made of an electrically insulating material having a first end inserted in a seat provided in the first body and a second end inserted in a seat provided in the second body.

### TECHNICAL FIELD OF APPLICATION

The present invention concerns the technical field of the welding of metallic materials.

More specifically, the present invention concerns the construction of a torch used in welding devices and equipped with a cooling system.

Even more specifically, the present invention concerns the construction of the cooling circuit of the torch.

The present invention concerns also a device using said torch.

### DESCRIPTION OF THE STATE OF THE ART

The use of technology for welding materials, typically metallic materials, is known in several sectors, especially in the industrial sector.

The technologies employed require the use of appropriate devices used by specialized operators.

These devices of the known type exploit the effect deriving from the generation of an electric arc. The process of generation of an electric arc can be exploited to weld metallic materials, with or without filler material.

Some welding technologies of the known type are grouped under the acronym GMAW (Gas Metal Arc Welding) and are also known as metal arc welding with shielding gas.

More specifically, it is possible to identify MIG (Metal-Inert-Gas) welding and MAG (Metal-Active-Gas) welding, which substantially differ due to the different gas that is used to protect the weld pool. Another welding technology of the known type is TIG (Tungsten Inert Gas) welding.

Said devices comprise an element designed to be handled by the operator, known as torch, in which a first end, or front end, serves for the actual welding operation and is arranged in proximity to the welding area.

At the opposite end of the torch, or rear end, there is a torch cable, or there are several cables, preferably grouped together, suited to connect the torch to one or more supply units.

Depending on the technology used, in fact, one or more fluids, for example a shielding gas for welding or a cooling gas, is/are conveyed into the torch. In the case of MIG welding, there is a unit for feeding the welding wire.

Thus, the device typically comprises a power supply unit, or generator, suited to supply power to the torch for the generation of the electric arc, and one or more units suited to supply the torch with the fluids necessary for its operation, for example a shielding gas cylinder or a cooling fluid supply unit.

The torch generally has a handgrip in an ergonomic shape, which makes it easy for the operator to handle it. The torch has typically an elongated shape, with a central gripping area and said front and rear ends.

According to the known technique, the front end comprises an electrode, or cathode, positioned inside a metallic nozzle that serves to center and convey the shielding gas.

The electric arc is generated between the cathode, constituted by the electrode, and the anode, constituted by the workpiece, which is electrically connected to the generator.

The nozzle is connected to a metallic tubular element, or external mantle, which extends longitudinally towards the handgrip.

During operation, the generator supplies power to the torch to generate and maintain the electric arc and a hydraulic circuit conveys the cooling fluid for the electrode towards the front terminal zone, where the arc is generated.

During operation, therefore, both the electric current for the generation of the arc and the cooling fluid flow simultaneously in the torch.

Torch manufacturers feel the need to be able to guarantee the best possible insulation between said electric and hydraulic circuits.

It is thus an object of the invention to provide a torch that makes it possible to improve the insulation between the electric and hydraulic circuits inside the torch itself.

It is another object of the invention to provide a torch that makes it possible to reduce the overall dimensions compared to the torches of the known type.

### SUMMARY OF THE PRESENT INVENTION

According to a first aspect of the present invention, therefore, the same concerns a welding torch comprising a first terminal zone that serves for the welding operation and a second terminal zone, opposite the first zone, provided with connection means designed to connect said torch to a power supply unit, to a cooling fluid supply unit and to a welding shielding gas supply unit, said first terminal zone comprising an electrically conductive welding electrode suited to be electrically powered and an electrically conductive conveyor element externally associated with said electrode and electrically insulated, said conveyor element being provided with an outlet mouth suited to allow said shielding gas to be conveyed outside of said electrode, said torch comprising an intermediate interconnection zone, in turn comprising:
a first electrically conductive body suited to be connected to said power supply unit and to said electrode through a first conductor element;
a second electrically conductive body arranged so that it is spaced from said first electrically conductive body, said second body being connected to said conveyor element through a second conductor element arranged externally to said first conductor element and electrically insulated;

wherein said torch comprises a delivery way for said cooling fluid coming from said cooling fluid supply unit and directed towards said first terminal zone and a return way for said cooling fluid coming from said first terminal zone, wherein at least one way between said delivery way and said return way runs through said first body and said second body, said at least one way comprising a tubular element made of an electrically insulating material and having a first end suited to be inserted in a seat provided in said first body and a second end suited to be inserted in a seat provided in said second body.

In a possible embodiment, the seat of the first body is defined in a non-electrically conductive portion of the first body and/or the seat of the second body is defined in a non-electrically conductive portion of the second body.

In a preferred embodiment, the first end of the tubular element is suited to be inserted in the seat provided in the first body through mechanical interference in order to obtain a hydraulic sealing effect and/or the second end of the tubular element is suited to be inserted in the seat provided in the second body through mechanical interference in order to obtain a hydraulic sealing effect.

According to a preferred embodiment, the torch comprises a sealing ring interposed between the first end of the tubular element and the seat provided in the first body to obtain a hydraulic sealing effect and/or a sealing ring interposed between the second end of the tubular element and the seat provided in the second body to obtain a hydraulic sealing effect.

Preferably, the first end of the tubular element comprises a recessed perimeter seat suited to at least partially accommodate the sealing ring and/or the seat provided in the first body comprises a recessed perimeter seat suited to at least partially accommodate the sealing ring and/or the second end of the tubular element comprises a recessed perimeter seat suited to at least partially accommodate the sealing ring and/or the seat provided in the second body comprises a recessed perimeter seat suited to at least partially accommodate the sealing ring.

In a preferred embodiment, the tubular element comprises plastic material, preferably PETP.

In a preferred embodiment, the first body and/or the second body comprises metal, preferably brass.

According to a preferred embodiment, the first body comprises a through channel for the cooling fluid, which ends into the seat provided in the first body and/or the second body comprises a through channel for the cooling fluid, which ends into the seat provided in the second body.

Preferably, the through channel for the cooling fluid is defined in the delivery way and/or in the return way.

In a preferred embodiment, the first body comprises a connector for connection to the power supply unit.

According to a preferred embodiment, the first body and/or the second body comprises a through channel for the passage of the shielding gas.

Preferably, the second body comprises a through channel and the first conductor element can pass through it.

In a preferred embodiment, the electrode is provided with an inner channel for the passage of a welding wire.

According to a preferred embodiment, both said delivery way and said return way run through said first body and said second body, said delivery way comprising a tubular element made of an electrically insulating material and having a first end suited to be inserted in a first seat provided in said first body and a second end suited to be inserted in a first seat provided in said second body, and said return way comprising a tubular element made of an electrically insulating material and having a first end suited to be inserted in a second seat provided in said first body and a second end suited to be inserted in a second seat provided in said second body.

In a preferred embodiment, the delivery way and the return way for said cooling fluid define two cooling circuits.

Preferably, the torch according to the present invention belongs to the group of welding torches using GMAW (Gas Metal Arc Welding) technology.

According to another aspect of the present invention, the same concerns a welding device comprising a welding torch, wherein said torch is made according to the description provided above.

Preferably, the device comprises a power supply unit, a cooling fluid supply unit and a supply unit designed to supply a shielding gas for the welding operation.

### BRIEF DESCRIPTION OF THE DRAWINGS

Further advantages, objects and characteristics of the present invention are defined in the claims and will be illustrated in the following description, with reference to the enclosed drawings. In particular, in the drawings:

FIG. 1 shows an axonometric view of a torch according to a preferred embodiment of the invention, in a possible use in a welding device;

FIG. 2 shows the torch of FIG. 1 isolated from the rest and in a partially sectional view;

FIG. 3 shows a partially exploded view of a detail of the torch shown in FIG. 2;

FIG. 4 shows the partially exploded view of the torch of FIG. 2 from another point of view;

FIG. 5 shows some elements of FIG. 3;

FIG. 6 shows a side plan view of elements of the torch of FIG. 2;

FIG. 7 shows a top view of FIG. 6;

FIG. 8 shows the sectional view of FIG. 7 along line VIII-VIII;

FIG. 8A shows an enlarged detail of FIG. 8;

FIG. 9 shows the sectional view of FIG. 6 along line IX-IX;

FIG. 9A shows an exploded view of a detail of FIG. 9;

FIG. 10 shows a side view of FIG. 6 from the right;

FIG. 10A shows the sectional view of FIG. 6 along line X-X;

FIG. 11 shows the sectional view of FIG. 6 along line XI-XI;

FIG. 12 shows an axonometric view of a detail of a torch according to a second preferred embodiment of the invention;

FIG. 13 shows a partially exploded view of a detail of the torch of FIG. 12;

FIG. 14 shows the partially exploded view of the torch of FIG. 12 from another point of view;

FIG. 15 shows an axonometric view of a torch according to a variant embodiment of the invention, in a possible use in a welding device for semi-automatic/robotic applications.

### DETAILED DESCRIPTION OF THE PRESENT INVENTION

Although the present invention is described below with reference to its preferred embodiments illustrated in the drawings, the present invention is not limited to the embodiments described below and illustrated in the drawings. On the contrary, the embodiments described and illustrated clarify some aspects of the present invention, the scope of which is defined in the claims.

The present invention proved to be particularly advantageous in relation to the production of welding torches using MIG technology.

In general, the present invention proved to be particularly advantageous in relation to the production of welding torches using GMAW (Gas Metal Arc Welding) technology.

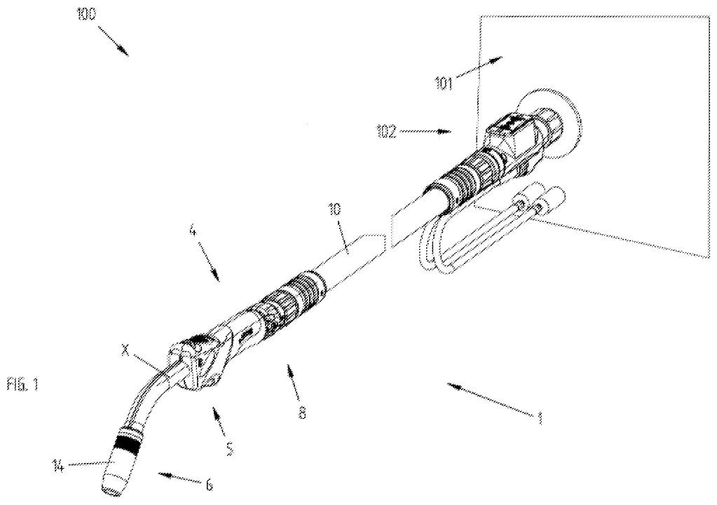

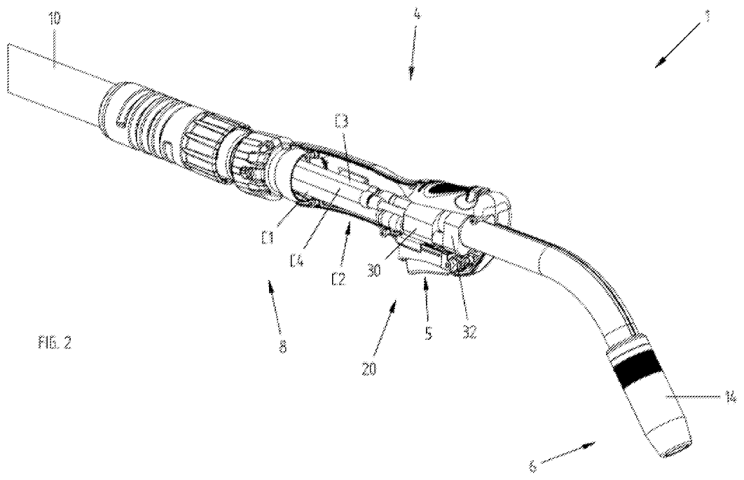

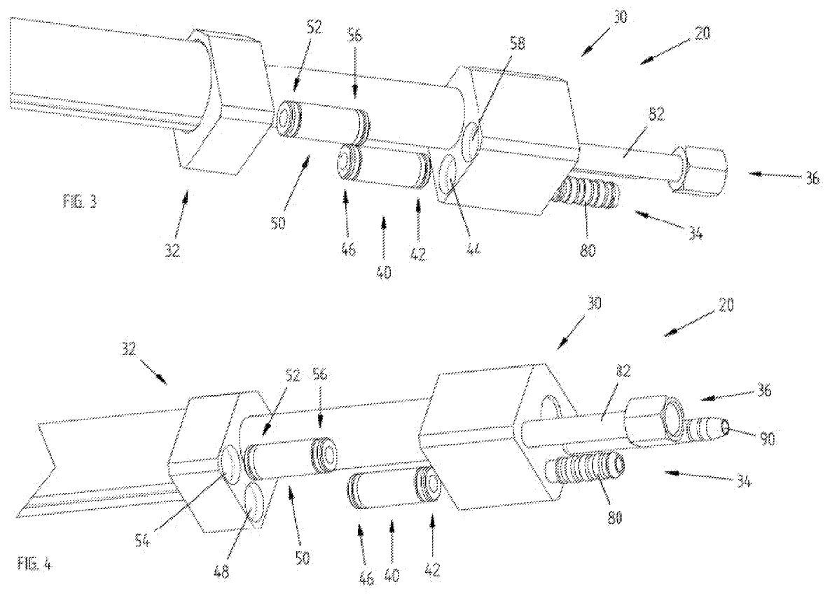

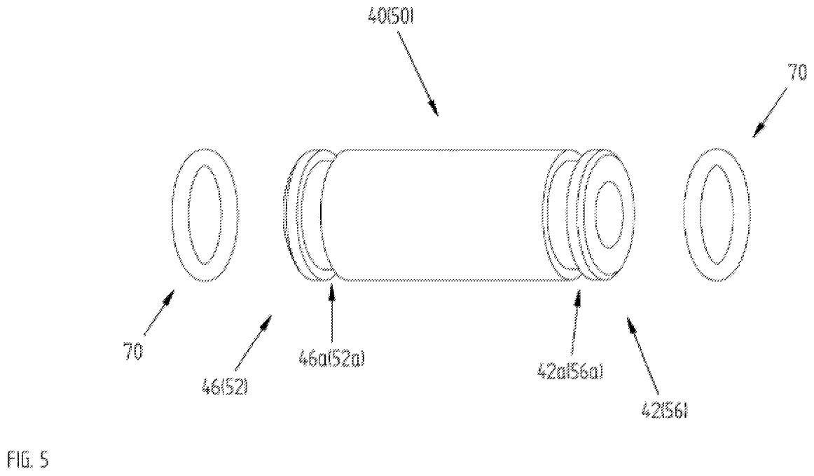

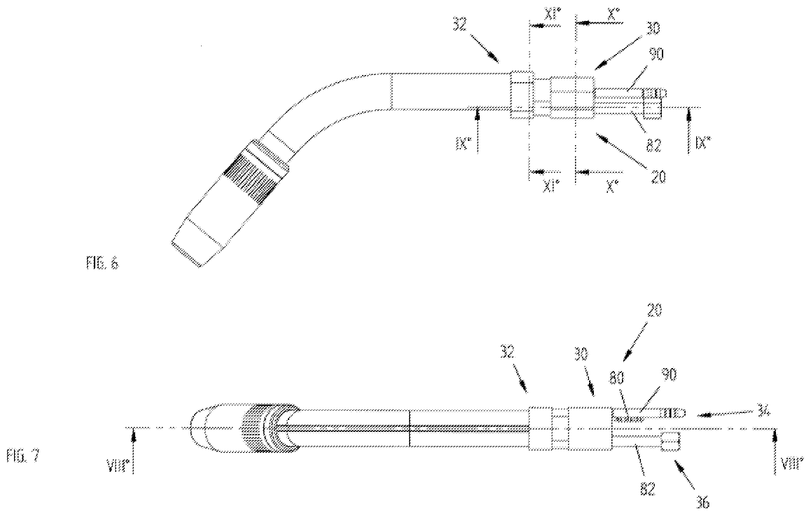

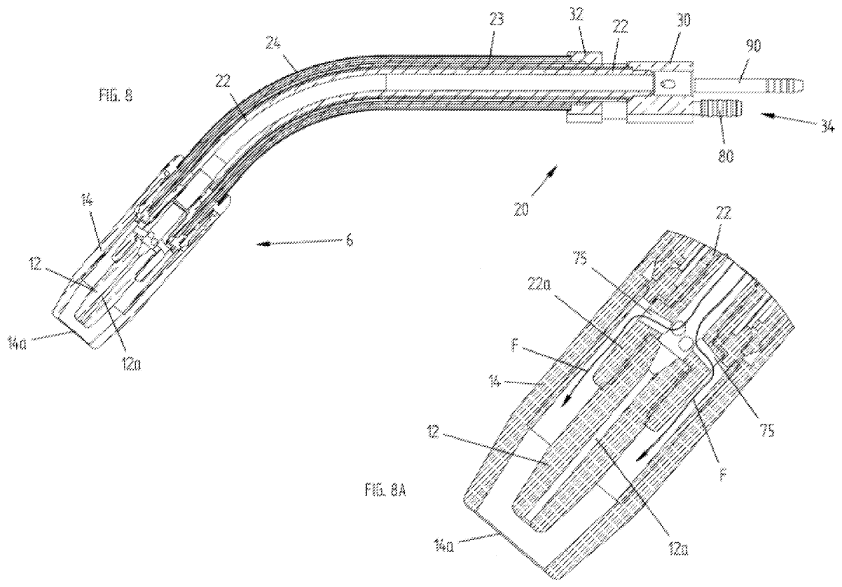

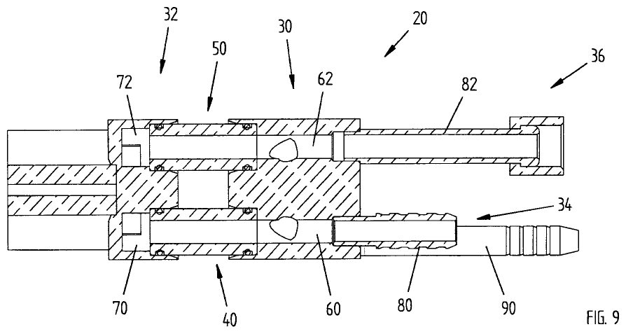

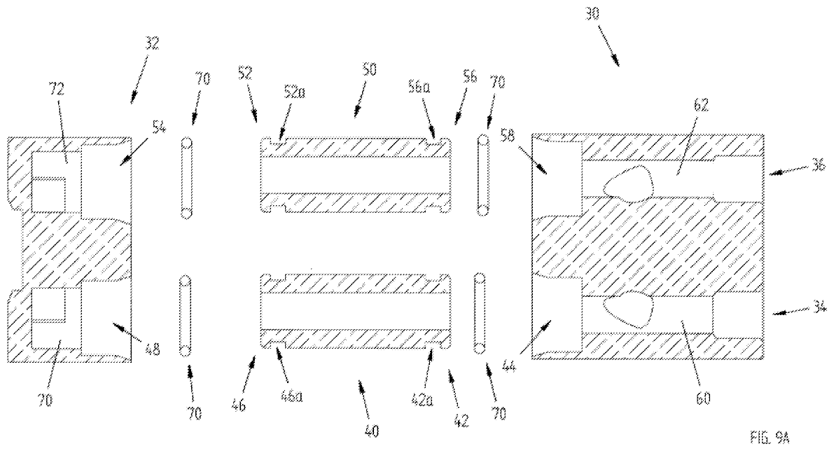

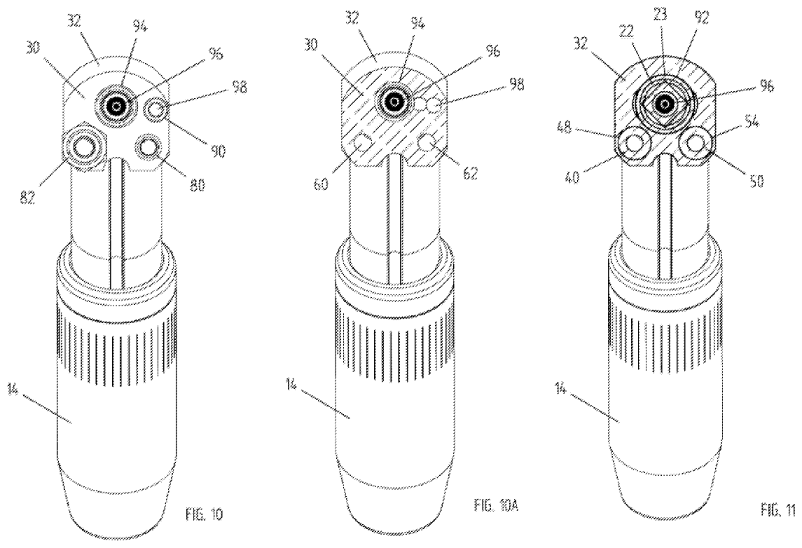

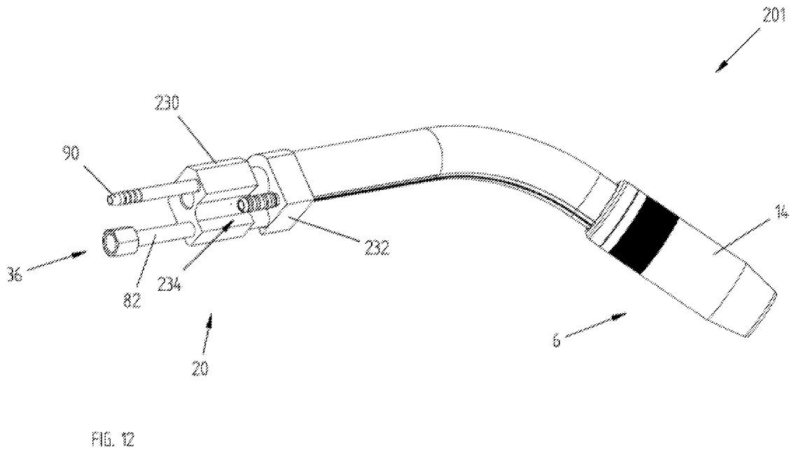

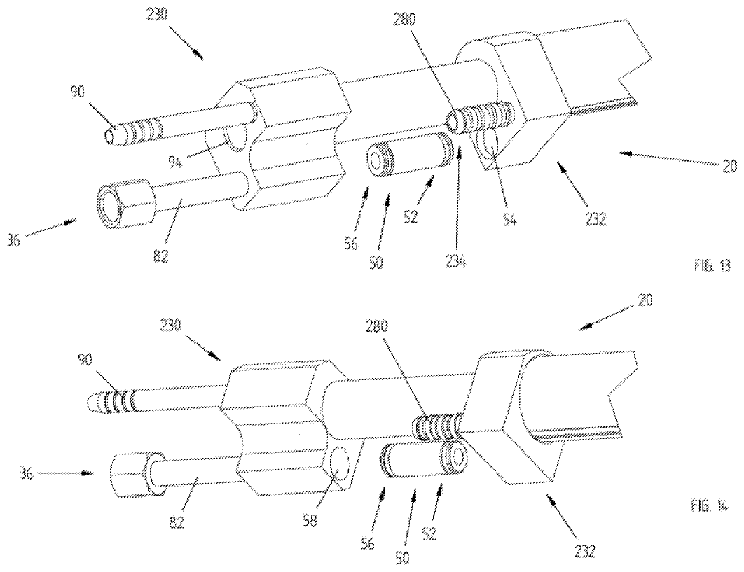

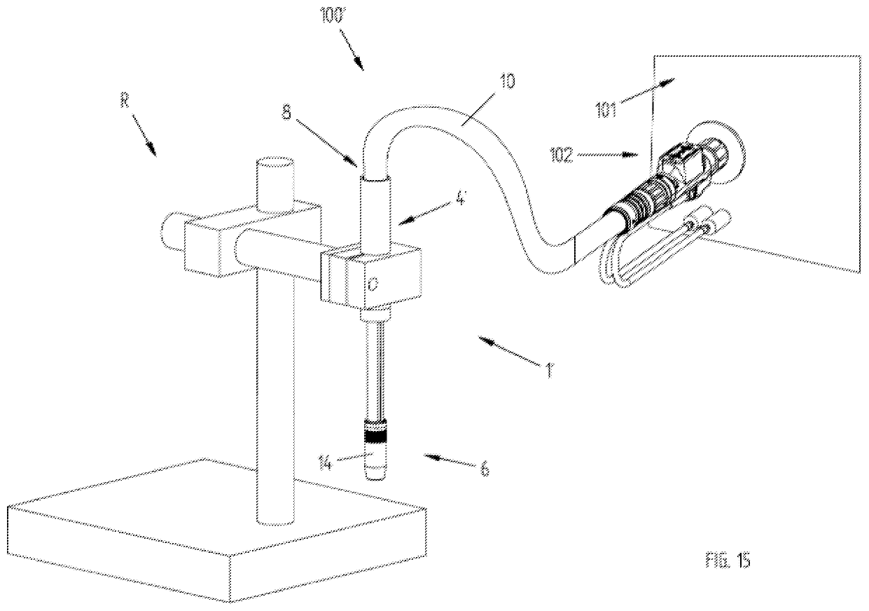

FIG. 1 schematically shows a welding device 100 using MIG technology, in which a torch according to a preferred embodiment of the invention is employed, said torch being indicated as a whole by 1 and illustrated in detail in the Figures from 1 to 11.

The welding device 100 preferably comprises said welding torch 1 applied to a supply unit 101, only the front part of which is shown in FIG. 1. The supply unit 101 is not described in detail, being of the known type, and preferably comprises an arc current generator unit (or power supply unit), a shielding gas supply unit and a cooling fluid supply unit. In the case of MIG welding with filler material, the supply unit 101, furthermore, preferably comprises a welding wire feed and advance unit.

The supply unit 101 and the torch 1 are preferably connected by connection means 10, or torch cable. The torch cable 10 preferably conveys the arc current, the shielding gas, the cooling fluid and the welding wire towards the torch 1.

The torch cable 10 preferably comprises an external protection casing or sheath. The torch cable 10 generally comprises several cables/pipes, which can be separate and/or coaxial.

The cables/pipes C1, C2, C3, C4 can be seen in greater detail in FIG. 2.

The cables/pipes C1, C2, C3, C4 can be connected to a first body 30 of the torch, as better described below.

The torch cable 10 is preferably removably connected to the supply unit 101, preferably by means of a connector 102.

To advantage, the torch 1 has an elongated and ergonomic shape, which is suited to make it easier to grasp it. Preferably, the torch 1 comprises a main body 4 suited to be grasped by the user, a first terminal zone 6 that serves for the welding operation and a second terminal zone 8 which is opposite the first zone 6 and connected to said torch cable 10.

The main body 4 is preferably associated with control means 5, preferably push buttons, which can be easily reached by the user to activate the proper welding controls.

The first terminal zone 6 comprises a welding electrode 12 made of an electrically conductive material, preferably copper, suited to be electrically powered, and a conveyor element 14 which is made of an electrically conductive material, too, externally associated with the electrode 12 and electrically insulated.

The conveyor element 14 is provided with an outlet mouth 14a (FIGS. 8 and 8A) suited to allow a flow F of shielding gas to be conveyed externally to the electrode 12.

According to the invention, the torch 1 comprises also an intermediate interconnection zone 20 comprising said first electrically conductive body 30 suited to be connected to the power supply unit through the torch cable 10 on one side, as previously explained, and connected to the electrode 12 through a first conductor element 22, as can be better observed in the sectional view shown in FIG. 8.

The first conductor element 22 is preferably constituted by a tubular element extending longitudinally and made of an electrically conductive material, which is connected to the first body 30 at one first end and to the electrode 12 at the opposite end.

The first conductor element 22 allows the passage of the arc current coming from the power supply unit until it reaches the electrode 12.

The intermediate interconnection zone 20 comprises also a second electrically conductive body 32, arranged so that it is spaced from the first body 30, wherein the second conductor body 32 is connected to the conveyor element 14 through a second conductor element 24.

The conveyor element 14 is preferably connected to the second conductor element 24 through a screwing operation.

In a variant embodiment, the conveyor element and the second conductor element may be connected in a different way or even made in a single piece and constitute a single body.

The second conductor element 24 is preferably constituted by a tubular element extending longitudinally and arranged externally to the first conductor element 22, and is electrically insulated with respect to the first conductor element 22 itself.

Preferably, a tubular element 23 made of an electrically insulating material is interposed between the first conductor element 22 and the second conductor element 24.

Always according to the preferred embodiment of the present invention, the torch 1 comprises a delivery way 34 for the cooling fluid coming from the cooling fluid supply unit that flows through the first body 30 and the second body 32 to reach the first terminal zone 6, and a return way 36 for the cooling fluid coming from the terminal zone 6 that flows through the second body 32 and the first body 30 in the opposite direction.

It should be noted that the terms “delivery way” and “return way” generically indicate a passageway for the cooling fluid, without any limitation with regard to the actual configuration of the same. The delivery way or the return way can comprise, for example, a single hydraulic circuit for the various parts of the torch, more specifically the parts to be cooled, or it may comprise several conveniently configured circuits, communicating or non-communicating.

According to the present preferred embodiment, a configuration with double cooling circuit is preferably considered, meaning that the cooling fluid is distributed in two cooling circuits that serve the function to cool the elements which are heated during the welding process, in particular the first conductor element 22, the electrode 12 and the second conductor element 24 which is connected to the conveyor element 14.

The two cooling circuits preferably define an inner circuit that allows the cooling of the internal elements such as the first conductor element 22 and the electrode 12, and an outer circuit that allows the cooling of the external elements such as the second conductor element 24 and the conveyor element 14.

Furthermore, the cooling circuit/circuits can be made with a configuration in series or in parallel, according to the known technique.

The configuration of these circuits does not belong to the sphere of interest of the present invention and therefore will not be illustrated in detail in the present description.

According to an aspect of the present invention, the delivery way 34 between the first body 30 and the second body 32 preferably comprises a first tubular element 40 made of an electrically insulating material and having a first end 42 suited to be inserted in a first seat 44 provided in the first body 30 and a second end 46 suited to be inserted in a first seat 48 provided in the second body 32. According to an aspect of the present invention, the return way 36 between the second body 32 and the first body 30 comprises a second tubular element 50 made of an electrically insulating material and having a first end 52 suited to be inserted in a second seat 54 provided in the second body 32 and a second end 56 suited to be inserted in a second seat 58 provided in the first body 30.

The first tubular element 40 and the second tubular element 50 preferably comprise hollow cylindrical elements and the seats 44, 48, 54, 58 provided in the two bodies 30, 32 preferably comprise cylindrical seats.

In the preferred embodiment illustrated and described herein, the seats 44, 48, 54, 58 of the two bodies 30, 32 are directly made in the electrically conductive material of the respective body 30, 32.

In variant embodiments not illustrated herein said seats may be defined in convenient non-electrically conductive portions of the respective first or second body.

The first end 42 of the first tubular element 40 is preferably suited to be inserted in the first seat 44 of the first body 30 through mechanical interference in order to obtain a desired hydraulic sealing effect, the second end 46 of the first tubular element 40 is preferably suited to be inserted in the first seat 48 of the second body 32 through mechanical interference in order to obtain a desired hydraulic sealing effect, the first end 52 of the second tubular element 50 is preferably suited to be inserted in the second seat 54 of the second body 32 through mechanical interference in order to obtain a desired hydraulic sealing effect, the second end 56 of the second tubular element 50 is preferably suited to be inserted in the second seat 58 of the first body 30 through mechanical interference in order to obtain a desired hydraulic sealing effect.

In order to facilitate the insertion of the first tubular element 40 in the first and in the second body 30, 32 and the insertion of the second tubular element 50 in the first and in the second body 30, 32 while at the same time guaranteeing tightness with respect to the liquid that flows through them during operation, sealing elements 70, preferably rubber O rings, are used.

A sealing ring 70 is preferably interposed between the first end 42 of the first tubular element 40 and the first seat 44 of the first body 30, a sealing ring 70 is preferably interposed between the second end 46 of the first tubular element 40 and the first seat 48 of the second body 32, a sealing ring 70 is preferably interposed between the first end 52 of the second tubular element 50 and the second seat 54 of the second body 32, and a sealing ring 70 is preferably interposed between the second end 56 of the second tubular element 50 and the second seat 58 of the first body 30.

To advantage, the sealing ring 70, thanks to the radial compression to which it is subjected, guarantees the desired hydraulic sealing effect.

The first end 42 of the first tubular element 40 preferably comprises a recessed perimeter seat 42a (FIG. 5) suited to at least partially accommodate the sealing ring 70, the second end 46 of the first tubular element 40 comprises a recessed perimeter seat 46a suited to at least partially accommodate the sealing ring 70, the first end 52 of the second tubular element 50 comprises a recessed perimeter seat 52a suited to at least partially accommodate the sealing ring 70, the second end 56 of the second tubular element 50 comprises a recessed perimeter seat 56a suited to at least partially accommodate the sealing ring 70.

In a variant embodiment, not illustrated herein, the first seat 44 and/or the second seat 58 provided in the first body 30 may comprise a recessed perimeter seat suited to at least partially accommodate the sealing ring 70, or the first seat 48 and/or the second seat 54 provided in the second body 32 may comprise a recessed perimeter seat suited to at least partially accommodate the sealing ring 70.

In a preferred embodiment, the first tubular element 40 and the second tubular element 50 comprise plastic material, more preferably they are made of PETP.

In variant embodiments different materials may be used, such as thermosetting resins, epoxy resins, silicone resins, polyester, nylon.

The first body 30 preferably comprises a through delivery channel 60 for the cooling fluid, which ends into the first seat 44, and preferably comprises a through return channel 62 for the cooling fluid, which ends into the second seat 58 (FIG. 9A).

The second body 32 preferably comprises a through delivery channel 70 for the cooling fluid, which ends into the first seat 48, and preferably comprises a through return channel 72 for the cooling fluid, which ends into the second seat 54.

A connector 80, preferably welded to the first body, is used to connect the through delivery channel 60 for the cooling fluid of the first body 30 to the pipe C1 of the torch cable 10 that supplies the fluid itself. The pipe C1 is preferably made of plastic material, for example PVC or silicone or rubber, and is preferably connected to the connector 80 through a metal clamp.

A connector 82 is used to connect the through return channel 62 for the cooling fluid of the first body 30 to the cable C2 of the torch cable 10 for the return of the fluid itself. The connector 82 and the cable C2 are preferably made of electrically conductive material, preferably brass or copper.

In fact, the cable C2, in addition to being designed to convey the cooling fluid of the cooling circuit, also constitutes the conductor of the arc current coming from the power supply unit.

The arc current thus reaches the electrode 12 starting from the power supply unit and through the cable C2, the first body 30 and the first conductor element 22.

As is known, the arc current passes from the electrode 12 to the workpiece, which is earthed.

During the welding operation, the conveyor element 14 can come into contact with the workpiece. In this case, the conveyor element 14, the second conductor element 24 and the second body 32, all electrically connected to one another, are also earthed.

Always in this case, therefore, the first and the second body 30, 32 are set with a difference in potential.

According to an advantageous aspect of the present invention, thanks to the use of the two tubular elements 40, 50 made of an electrically insulating material and to their insertion inside the first and the second body 30, 32, the insulation between the first and the second body 30, 32 is greater compared to the systems of the known type.

According to another point of view, given the same losses between the first and the second body 30, 32, the same bodies 30, 32 can be arranged at a shorter distance compared to the systems of the known type, thus reducing the overall dimensions and the size of the torch 1.

In addition to what has been described above, a wire guide cable C3 makes it possible to feed a welding wire coming from the welding wire feed unit. The wire guide cable C3 is connected to the first body 30 and a wire guide sheath 96 extends from the connector 102 to the electrode 12.

For this purpose, the first body 30 preferably comprises a through channel 94 (FIG. 10) for the passage of the wire guide sheath 96 and analogously the second body 32 preferably comprises a through channel 92 (FIG. 11) for the passage of the wire guide sheath 96. The wire guide sheath 96 then reaches the electrode 12, preferably running inside the first conductor element 22.

Furthermore, the electrode 12 is preferably provided with an inner channel 12a (FIG. 8A) for the passage and advance of the welding wire.

The subject of the present invention does not include the aspects regarding the passage of the welding wire, which therefore are not described in further detail herein.

Moreover, it should be noted that also the first conductor element 22 is arranged inside the through channel 92 of the second body 32 so that it passes therethrough and is connected to the first body 30 on one side and to the electrode 12 on the opposite side.

In addition to the above, a pipe C4 conveys the welding shielding gas coming from the gas supply unit into the first body 30.

The pipe C4 is connected to the first body 30 and the shielding gas is conveyed from the first body 30 to the level of the electrode 12.

The pipe C4 is connected to the first body 30 through a spout 90 and preferably through a metal clamp (not shown herein).

In a variant embodiment, not shown herein, the shielding gas can flow inside said wire guide cable C3 together with the wire guide sheath 96 and the welding wire.

In this case, the first body 30 will not be provided with the spout 90.

The first body 30 preferably comprises a through channel 98 for the passage of the shielding gas and inside the first body 30 the through channel 98 is shaped in such a way as to carry the gas flow towards the centre area and inside the through channel 94 that accommodates also the wire guide sheath 96, as visible in FIG. 10A. The gas flow is located inside the through channel 94 and outside the wire guide sheath 96.

The gas flow then reaches the electrode 12, preferably flowing inside the first conductor element 22 and always outside the wire guide sheath 96.

At the level of the electrode 12, the gas flow F diffuses outside the electrode 12 preferably through suitable holes 75 (FIG. 8A). The diffusion holes 75 are preferably made in a terminal part 22a of the first conductor element 22. The terminal part 22a of the first conductor element 22 is made of a conductive material and is preferably connected to the first conductor element 22 through a screwing operation. The subject of the present invention does not include the aspects concerning the passage of the shielding gas and therefore are not described in further detail.

Figures from 12 to 14 show the construction details of a torch 201 according to a variant embodiment of the invention. The characteristics and/or component parts corresponding or equivalent to those of the first embodiment previously described are identified by the same reference numbers.

This embodiment differs from the embodiment described above in that the delivery way 234 for the cooling fluid coming from the cooling fluid supply unit does not run through the first body 230 to reach the second body 232 but reaches the second body 232 directly.

The return way 36, instead, maintains its configuration and, according to the advantageous aspect of the invention, comprises a tubular element 50 that hydraulically connects the second body 232 to the first body 230, as previously described.

The second body 232 comprises a connector 280, preferably welded to the second body 232, which is directly connected to the pipe Cl conveying the fluid coming from the cooling fluid supply unit.

FIG. 15 shows a variant embodiment of the welding device, indicated as a whole by 100′, which comprises a welding torch 1′ according to a variant embodiment of the invention. The device 100′ and the torch 1′ according to said embodiment differ from the embodiment shown in FIG. 1 in that they are configured to be used in a semi-automatic/robotic application.

The welding device 100′ preferably comprises said welding torch 1′ applied to a supply unit 101, analogously to what has been described above.

The supply unit 101 and the torch 1 are preferably connected by connection means 10, or torch cable. Preferably, the torch cable 10 is removably connected to the supply unit 101, preferably through a connector 102.

The torch 1′ differs from the torch 1 illustrated and described above in that it is provided with a main body 4′ suited to be connected preferably to a semi-automatic piece of equipment R or to a robot (not illustrated), for example an anthropomorphic arm, and in that it is not provided with control means associated with the main body 4′.

The torch 1′ will be conveniently controlled automatically by a control unit of the device 100′.

It has thus been shown, by means of the present description, that the torch according to the present invention makes it possible to achieve the set objects. More specifically, the torch according to the present invention makes it possible to improve the insulation between electric and hydraulic circuits inside the torch with respect to the torches of the known type and/or to reduce the overall dimensions.

Even though the present invention has been illustrated above through the detailed description of its embodiments shown in the figures, the present invention is not limited to the embodiments described above and illustrated in the drawings; on the contrary, further variants of the embodiments described herein fall within the scope of the present invention, which is defined in the claims.

1. A welding torch (1; 1′; 201) comprising a first terminal zone (6) intended for welding and a second terminal zone (8), opposite the first zone (6), provided with connection means (10) suited to connect said torch (1; 1′; 201) to a power supply unit, to a cooling fluid supply unit and to a welding shielding gas supply unit, said first terminal zone (6) comprising an electrically conductive welding electrode (12) suited to be electrically powered and an electrically conductive conveyor element (14) externally associated with said electrode (12) and electrically insulated, said conveyor element (14) being provided with an outlet mouth (14a) designed to allow said shielding gas to be conveyed outside of said electrode (12), said torch (1; 1′; 201) comprising an intermediate interconnection zone (20), in turn comprising:
a first electrically conductive body (30) suited to be connected to said power supply unit and to said electrode (12) by means of a first conductor element (22);
a second electrically conductive body (32) arranged so that it is spaced from said first electrically conductive body (30), said second body (32) being connected to said conveyor element (14) by means of a second conductor element (24) arranged externally to said first conductor element (22) and electrically insulated;
wherein said torch (1; 1′; 201) comprises a delivery way (34, 234) for said cooling fluid coming from said cooling fluid supply unit and directed towards said first terminal zone (6) and a return way (36) for said cooling fluid coming from said first terminal zone (6), wherein at least one way between said delivery way (34, 234) and said return way (36) crosses said first body (30) and said second body (32), said at least one way comprising a tubular element (40, 50) made of an electrically insulating material and having a first end (42, 56) suited to be inserted in a seat (44, 58) provided in said first body (30) and a second end (46, 52) suited to be inserted in a seat (48, 54) provided in said second body (32).

2. The torch (1; 1′; 201) according to claim 1, wherein said first end (42, 56) of said tubular element (40, 50) is suited to be inserted in said seat (44, 58) provided in said first body (30) through mechanical interference in order to obtain a hydraulic sealing effect and/or said second end (46, 52) of said tubular element (40, 50) is suited to be inserted in said seat (48, 54) provided in said second body (32) through mechanical interference in order to obtain a hydraulic sealing effect.

3. The torch (1; 1′; 201) according to claim 1, wherein it comprises a sealing ring (70) interposed between said first end (42, 56) of said tubular element (40, 50) and said seat (44, 58) provided in said first body (30) in order to obtain a hydraulic sealing effect and/or a sealing ring (70) interposed between said second end (46, 52) of said tubular element (40, 50) and said seat (48, 54) provided in said second body (32) in order to obtain a hydraulic sealing effect.

4. The torch (1; 1′; 201) according to claim 3, wherein said first end (42, 56) of said tubular element (40, 50) comprises a recessed perimeter seat (42a, 56a) suited to at least partially accommodate said sealing ring (70) and/or said seat (44, 58) provided in said first body (30) comprises a recessed perimeter seat suited to at least partially accommodate said sealing ring (70) and/or said second end (46, 52) of said tubular element (40, 50) comprises a recessed perimeter seat (46a, 52a) suited to at least partially accommodate said sealing ring (70) and/or said seat (48, 54) provided in said second body (32) comprises a recessed perimeter seat suited to at least partially accommodate said sealing ring (70).

5. The torch (1; 1′; 201) according to claim 1, wherein said tubular element (40, 50) comprises a plastic material, preferably PETP.

6. The torch (1; 1′; 201) according to claim 1, wherein said first body (30) and/or said second body (32) comprises a metal, preferably brass.

7. The torch (1; 1′; 201) according to claim 1, wherein said first body (30) comprises a through channel (60, 62) for said cooling fluid, which ends into said seat (44, 58) provided in said first body (30) and/or said second body (32) comprises a through channel (70, 72) for said cooling fluid, which ends into said seat (48, 54) provided in said second body (32).

8. The torch (1; 1′; 201) according to claim 7, wherein said through channel (60, 62, 70, 72) for said cooling fluid is defined in said delivery way (34, 234) and/or in said return way (36).

9. The torch (1; 1′; 201) according to wherein said first body (30) comprises a connector (82) for connection to said power supply unit.

10. The torch (1; 1′; 201) according to claim 1, wherein said first body (30) and/or said second body (32) comprises a through channel (98, 92) for the passage of said shielding gas.

11. The torch (1; 1′; 201) according to claim 1, wherein said second body (32) comprises a through channel (92) through which said first conductor element (22) can pass.

12. The torch (1; 1′; 201) according to claim 1, wherein said electrode (12) is provided with an inner channel (12a) for the passage of a welding wire.

13. The torch (1; 1′; 201) according to claim 1, wherein both said delivery way (34) and said return way (36) run through said first body (30) and said second body (32), said delivery way (34) comprising a tubular element (40) made of an electrically insulating material and having a first end (42) suited to be inserted in a first seat (44) provided in said first body (30) and a second end (46) suited to be inserted in a first seat (48) provided in said second body (32), and said return way (36) comprising a tubular element (50) made of an electrically insulating material and having a first end (56) suited to be inserted in a second seat (58) provided in said first body (30) and a second end (52) suited to be inserted in a second seat (54) provided in said second body (32).

14. A device (100; 100′) for making welds, comprising a welding torch (1; 1′; 201), wherein said torch (1; 1′; 201) is made according to claim 1.

15. The device (100; 100′) according to claim 14, wherein it comprises a power supply unit, a cooling fluid supply unit and a welding shielding gas supply unit.
